(19) United States
(12) Patent Application Publication
(10) Pub. No.: US 2026/0309251 A1
(43) Pub. Date: Oct. 8, 2026

(54) ELECTRIC BLEED OFF VALVE ASSEMBLY

(71) Applicant: FMC Technologies, Inc., Houston, TX (US)

(72) Inventor: James Cook, Houston, TX (US)

(21) Appl. No.: 19/172,284

(22) Filed: Apr. 7, 2025

(51) Int. Cl. F16K 31/06; F16K 31/124; G05D 7/01

(52) U.S. Cl. CPC F16K 31/0668; F16K 31/124; G05D 7/0186

(57) ABSTRACT

Systems and methods of controlling pressure bleed off by a bleed off valve assembly are disclosed. In some embodiments, a bleed off line is positioned along a main line. The bleed off line comprises a bleed off valve (BOV) and a first valve configured to provide fluid communication between the BOV and the main line. The BOV is configured to close under electrical energy to prevent the flow of the fluid through the BOV. When the electrical energy is removed, the BOV is operable to open under pressure from the fluid. The flow of the fluid through the BOV assembly may further be controlled by a choke and a choke saver positioned downstream of the BOV. In some embodiments, the electrically controlled BOV assembly is positioned parallel with a pressure relief system along the main line.

### BACKGROUND

### 1. Field

Embodiments of the current disclosure relate to electric bleed off valves in the oil and gas industry. More specifically, embodiments of the current disclosure relate to a pressure-activated electric bleed off valve for main line pressure bleed off.

### 2. Related Art

In typical oil and gas systems, particularly pressure pumping (or hydraulic fracturing) applications, pressure needs to be bled off from the main line of oil and gas wells at various locations to perform maintenance, replace parts, change pipe configurations, and the like. To accomplish the bleed off procedures, typically, two valves are provided inline in a bleed off line. The valves are operable to allow fluid to flow through the bleed off line when opened. In typical operations, a first valve is generally left open, and a second valve is operated to slowly bleed off pressure from the main line. The second valve is manually opened a small amount to allow the fluid to depressurize through the bleed off assembly. Because the fluid is under high pressure, the fluid flows quickly and turbulently through the second valve, thereby cutting or otherwise damaging the second valve. The abrasive nature of the fluid can also contribute to wear and degradation of the second valve. After several operations, the first valve is closed cutting off fluid communication between the main line and the second valve, and the second valve is replaced. In typical operations, human operators physically actuate these valves. As such, high labor costs and replacement parts are often required in typical operations.

Furthermore, typical pressure bleed off systems may comprise a choke downstream of the second valve. The second valve may be opened as quickly as possible leaving the downstream choke to control the flow rate of the exiting fluid. To operate the second valve quickly enough to reduce damage to the second valve, hydraulic actuators are typically used. Furthermore, electric actuators may not have the response time to open the valve quickly enough to prevent/reduce valve cutting. Therefore, hydraulic systems are preferred over electric systems. The hydraulic systems necessary to provide high-speed control of the fluid through the second valve are expensive and cumbersome often requiring their own skid mounted system to effectively operate.

What is needed are systems and methods of remotely operating bleed off valves while minimizing damage to the associated equipment. Furthermore, what is needed are systems and methods of remotely operated, fully electrically powered and actuated bleed off valve systems that minimize damage to bleed off components.

### SUMMARY

Embodiments of the current disclosure solve the above-described problems and provide a distinct advance in the art by providing systems and methods of controlling bleed off processes in a main line of an oil and gas system by remote control of electric bleed off valves.

An embodiment of the current disclosure comprises an electric bleed off valve assembly for bleeding off pressure. The electric bleed off valve assembly comprises a first valve operable to open and close and configured to allow fluid to flow through a bleed off line when open and prevent the fluid from flowing when closed, a bleed off valve provided downstream from the first valve and operable to open under pressure from the fluid and configured to allow the fluid to flow when open and prevent the fluid from flowing when closed, wherein the bleed off valve is electrically operable to close and operable to open under pressure from the fluid, and a choke provided downstream of the bleed off valve and operable to restrict flow of the fluid therethrough.

Another embodiment of the current disclosure comprises a method of controlling pressure bleed off in a bleed off line of an oil and gas system. The method comprises energizing a solenoid to maintain a closed position of a bleed off valve preventing flow of a fluid through a pressure bleed off line, de-energizing the solenoid allowing the bleed off valve to transition from the closed position to an open position, opening the bleed off valve by providing pressure to a valve member of the bleed off valve and forcing the valve member to actuate allowing the flow of the fluid from upstream of the bleed off valve to downstream of the bleed off valve in the bleed off line, and controlling the flow of the fluid by a choke provided downstream of the bleed off valve.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary oil and gas system main line and bleed off valve line;

FIGS. 2A-2B depict configurations of a bleed off valve assembly for some embodiments of the disclosure;

FIG. 3 depicts an embodiment of a bleed off valve assembly connected to the main line;

FIG. 4 depicts an embodiment of a parallel assembly of a bleed off valve and a pressure release valve; and

FIG. 5 illustrates an exemplary process of pressure bleed off from the main line by the bleed off valve assembly.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the current technology can include a variety of combinations and/or integrations of the embodiments described herein.

Generally, embodiments of the current disclosure provide systems and methods of an electrically operable bleed off valve assembly. In some embodiments, the bleed off valve assembly includes a first valve and a second valve positioned downstream from the first valve. The first valve may generally be left open to provide fluid communication between a main line (or any line) of an oil and gas system and the second valve. The second valve may be operable by electric energy to remain closed. When bleed off operation begins, the electrical energy may be stopped by operation of a switch or relay. When the energy causing the second valve to close is removed, the second valve may then be opened by the pressure of the fluid in the main line and pressure bleed line forcing the second valve open. After the pressure is bled off in the main line, the second valve may be operable to be closed by again providing electrical energy to the second valve to close and hold the second valve closed. Furthermore, in some embodiments, a choke may be provided downstream of the second valve to control the flow of the fluid through the bleed off line. Furthermore, in some embodiments, the bleed off valve line described herein may be positioned in parallel with a pressure relief line along the main line of the oil and gas system. The bleed off line and the pressure relief line may provide the expelled fluid to an expulsion tank.

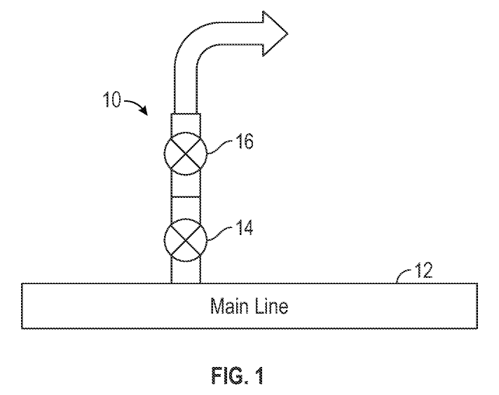

FIG. 1 depicts an exemplary bleed off line 10 comprising a system of valves used to perform bleed off procedures in oil and gas well systems. Here, fluid may flow under high pressure through the main line 12. In some embodiments, main line 12 may be the main bore for hydraulic fracturing or, in some embodiments, pressure pumping slurry operations; however, main line 12 is representative of any oil and gas piping that may require pressure to be bled off for maintenance and/or any other purposes. Bleed off line 10 may couple to main line 12 at any point along main line 12. Furthermore, bleed off line 10 may be representative of a plurality of bleed off lines positioned at various locations along main line 12.

Here, bleed off line 10 comprises two in-line valves 14 and 16. In some embodiments, first valve 14 and second valve 16 may be flow control valves. Though any standard flow control valve may be used, first valve 14 can be a plug valve as described in embodiments herein. Second valve 16, in some embodiments, comprises a flow control valve that is operational by pressure to open and electrical energy to close. First valve 14, in some embodiments, is the plug valve and remains closed while second valve 16 also remains closed during typical operation. Closing both valves 14 and 16 during operation provides a dual barrier to the fluid. When pressure bleed off is initiated, upstream and downstream valves along main line 12 may be operated to close off a section of main line 12 to bleed off the pressure in the closed off section. In some embodiments, upstream and downstream valves may simply redirect flow to maintain operation of the fracturing system. First valve 14 may then be opened providing fluid communication between main line 12 and second valve 16. Second valve 16 may then be operated as described below.

To release pressure at a controlled rate, second valve 16 may be opened by transmitting a signal from a remote location by either wire or wirelessly to remove the electrical energy maintaining second valve 16 closed. Second valve 16 may then be forced open by the pressure in main line 12 bleed off line 10 resulting in pressure bleed off through bleed off line 10.

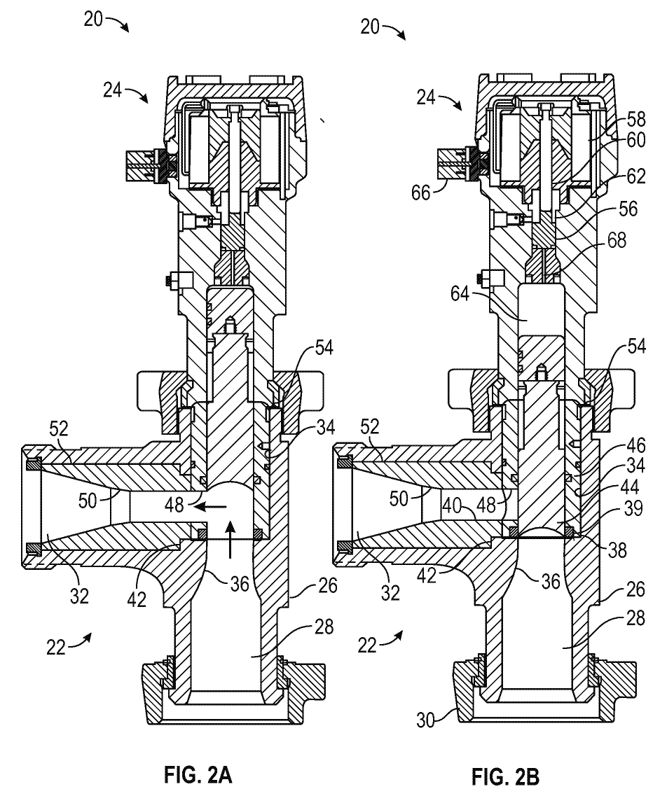

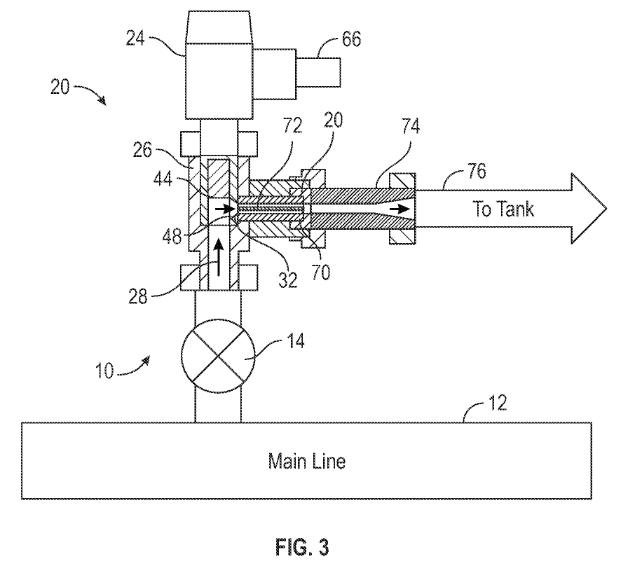

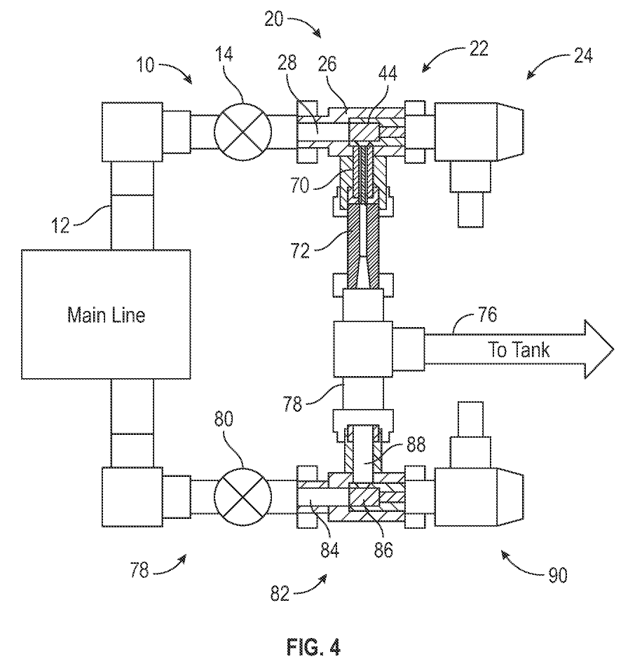

FIGS. 2A-2B depicts pressure-activated electric bleed off valve (BOV) assembly 20 comprising a T-type valve assembly. In some embodiments, second valve 16 is representative of BOV assembly 20, as BOV assembly 20 can be positioned along bleed off line 10 as described below and illustrated in FIG. 3 and 4. Here, BOV assembly 20 is in a T configuration; however, any in-line, Y-type, or any other configuration or arrangement may be used. In some embodiments, BOV assembly 20 comprises bleed off valve (BOV) 22 and a pilot valve 24. In the illustrative embodiment shown in FIGS. 2A-2B, BOV 22 includes a generally T-shaped valve body 26 including inlet bore 28 connectable by wing coupler 30, to bleed off line 10. Furthermore, inlet bore 28 is in fluid communication with outlet bore 32 via valve bore 34. Inlet bore 28 may comprise a reduced diameter portion 36 presenting a first shoulder 38 positioned between inlet bore 28 and valve bore 34, and the outlet bore 32 may similarly comprise a reduced diameter portion 40.

BOV 22 also includes a valve member 44 movable in the valve bore 34 between a closed position (FIG. 2B) in which the valve member 44 prevents the fluid from flowing between the inlet bore 28 and the outlet bore 32, and an open position (FIG. 2A) in which the valve member 44 permits fluid to flow (represented by the arrows) between the inlet bore 28 and the outlet bore 32. In the illustrative embodiment shown in FIGS. 2A and 2B, valve member 44 is a poppet that is slidably supported in a tubular poppet cage 46 that is positioned in the valve bore 34 against the first shoulder 38.

In some embodiments, poppet cage 46 includes at least one flow port 48 extending transversely through poppet cage 46 and is fluidly connected to outlet bore 32. Here, flow port 48 is fluidly connected to insert bore 50 extending through bore insert 52 positioned in outlet bore 32 against second shoulder 42.

In some embodiments, valve member 44 is configured to span flow port 48 when valve member 44 is in the closed position and extends above an upper end 54 of the valve body 26 when the valve member 44 is in the closed position. The valve member 44 may also include an enlarged diameter middle portion configured to engage an annular stop on an inner surface of the poppet cage 46 in order to limit further downward movement of the valve member 44 when the valve member 44 is in its closed position.

In some embodiments, the lower portion of valve member 44 is sealed to the poppet cage 46 by an annular seal located above the flow port 48. When the valve member 44 is in the closed position, the lower end is also sealed to the poppet cage 46 by a second annular seal located below the flow port 48. In this manner, when the valve member 44 is in the closed position, the lower end of valve member 44 can seal against the second annular seal 39 at shoulder 38 and prevent fluid in the inlet bore 28 from flowing into the outlet bore 32. When valve member 44 is in the open position, the bottom of the lower end of valve member 44 will be located above the flow port 48 and thus allow fluid to freely flow from the inlet bore 28 to the outlet bore 32.

In some embodiments, movement of valve member 44 from its closed position to its open position is in part controlled by pilot valve 24. Pilot valve 24 comprises a fluid chamber 64 configured to be filled with a substantially non-compressible fluid. The non-compressible fluid in the fluid chamber 64 is operatively engaged with valve member 44, that is, the non-compressible fluid in the fluid chamber 64 directly affects the operation of valve member 44 depending on the state of fluid chamber 64, which in turn is controlled by pilot valve 24. When pilot valve 24 is closed, fluid chamber 64 is closed, and the non-compressible fluid trapped in fluid chamber 64 prevents valve member 44 from moving from its closed position to its open position. When pilot valve 24 is open, fluid chamber 64 is open, and the unconstrained non-compressible fluid (e.g., hydraulic fluid) no longer prevents valve member 44 from moving from its closed position to its open position.

Movement of the pilot piston 56 from its closed position to its open position is affected by a solenoid 58. Solenoid 58 includes a plunger rod 60, the lower end of which extends through a seal sleeve 62 positioned in the upper bore section and engages the top of the pilot piston 56. When the solenoid 58 is energized via a current supplied through electrical connector 66 by wired or wireless connection the plunger rod 60 exerts a downward force on the pilot piston 56, which holds the pilot piston 56 in its closed position. When the solenoid 58 is de-energized, the downward force exerted by the plunger rod 60 is relieved and the pilot piston 56 is moved to its open position by the hydraulic fluid in the fluid chamber 64 forced by valve member 44 being forced to the open position by the pressure in inlet bore 28. In some embodiments, when solenoid 58 is de-energized, hydraulic fluid may be forced to exit the fluid chamber 64 through key hole 68 as the valve member 44 is opened by the pressure in the bleed off line 10. As such, BOV 22 is forced open by the fluid pressure in inlet bore 28 resulting in fast-acting actuation of BOV 22 from the closed position of FIG. 2B to the open position of FIG. 2A. Therefore, the fluid and pressure in inlet bore 28 and the upstream portion of bleed off line 10 is bled off through outlet bore 32 and on to the tank or reservoir downstream.

To close BOV 22, pressure is removed in the inlet bore 28 by closing first valve 14. Once pressure is removed from the poppet, springs in pilot valve are operable to push the fluid that vacated from the lower piston chamber 66 back and reseat valve member 44. Solenoid 58 may then be energized to prevent fluid transfer in the pilot valve 24. Additional discussion of the BOV 22 in operation as a pressure relief valve (described in more detail below) can be found in U.S. Patent No. 9,915,373 titled ELECTRONICALLY CONTROLLED PRESSURE RELIEF VALVE, which is incorporated by reference in its entirety herein.

As shown in FIG. 3, BOV assembly 20 is provided on bleed off line 10 in fluid communication with main line 12. In some embodiments, BOV assembly 20 comprises pilot valve 24, BOV 22, and first valve 14 in fluid communication with main line 12. Here, first valve 14 is a plug valve and may be opened to allow fluid from main line 12 to flow under pressure to BOV assembly 20. As described above, first valve 14 may be any general control valve, isolation valve, or the like in the industry. Furthermore, as described above, BOV assembly 20 may be, or replace, second valve 16. BOV assembly 20 may be operational as described above providing pressure bleed off to the downstream line 76 and then on to the expulsion tank.

In some embodiments, choke 70 is positioned at outlet bore 32. Here, outlet bore 32 provides a decreasing cross-sectional area channeling the flow of the fluid from main line 12 to the tank when valve member 44 is open. When valve member 44 is forced by the fluid pressure as described above to open BOV assembly 20, outlet bore 32 is provided in fluid communication with main line 12 placing the downstream line 76 of bleed off line 10 (“to tank”) and the tank in fluid communication with main line 12. As such, BOV assembly 20 is configured to provide the fluid from main line 12 to the tank thus bleeding pressure in main line 12.

In some embodiments, flow port 48 comprises a transitional cross section from a larger cross section upstream connecting to upstream bleed off line 10 to a smaller cross section at choke 70. Here, choke 70 is a linear choke comprising a fluid line 72 comprising a circular cross section that is reduced in diameter (cross-sectional area) from that of upstream bleed off line 10 and downstream line 76. As such, the flow of fluid is limited through choke 70. Choke 70 reduces the fluid bleed off and pressure bleed off rate by limiting the flow. As such, the pressure is not released all at once or as quickly as a larger surface area. In some embodiments, choke 70 is a bean choke and comprises for example, hardened steel, tungsten carbide, stainless steel and the like and is specifically designed to handle the high pressure, high flow rates, erosive flows, and turbulence of the flow through choke 70. Furthermore, in some embodiments, choke 70 may not be provided directly adjacent to outlet bore 32 and may be provided farther downstream as described in more detail below.

Choke 70 may be placed downstream of, and adjacent to, outlet bore 32. As such, outlet bore 32 may serve as a flow transition device providing a variable cross-sectional area to transition the flow from BOV 22 to choke 70. As described above, choke 70, in some embodiments, may be an inline choke with a diameter similar to, or equal to a portion of outlet bore 32. Furthermore, choke 70 may include a center shaft configured to reduce the cross-sectional area exposed to the fluid. As such, the effective cross-sectional area of choke 70 is reduced constricting the flow of the fluid therethrough and restricting the pressure bleed off rate.

In some embodiments, choke 70 may not be positioned adjacent to outlet bore 32. Intermediate components may be provided between outlet bore 32 and choke 70. For example, a conduit comprising a variable cross section may be provided. The conduit may provide flow control to increase or decrease the flow rate and/or the pressure prior to providing the fluid into choke 70. In some embodiments, a length of conduit may be provided to separate choke 70 from BOV 22 particularly if BOV 22 is a T- or Y-type valve.

As illustrated in FIG. 3, downstream of choke 70 is choke saver 74. Choke saver 74 slowly transitions the flow out of choke 70 to reduce turbulence and velocity and damage to the components. Choke saver 74 may be positioned adjacent (with no intermediate components) to choke 70 as shown, or choke saver 74 may be positioned farther downstream. However, as the purpose of choke saver 74, in some embodiments, is to increase flow line diameter and, in some embodiments, decrease velocity, choke saver 74 is positioned downstream of choke 70.

FIG. 4 depicts BOV assembly 20 configured in the bleed off line 10 in parallel with pressure relief line 78. In some embodiments, bleed off line 10 may be in fluid communication with main line 12, which may be in fluid communication with pressure relief line 78. Pressure relief line 78 comprises various control valves configured to relieve pressure in main line 12 when the pressure in main line 12 rises above a defined normal operating pressure.

In some embodiments, pressure relief line 78 comprises first pressure relief line valve 80 and second pressure relief valve (e.g., pressure relief valve (PRV) 82). First pressure relief line valve 80 may be any electrically, hydraulically, or manually actuated valve and, in some embodiments, is an isolation valve (e.g., plug valve, gate valve, ball valve, etc.) as describe in reference to first valve 14 above. In some embodiments, all valves depicted in FIGS. 3 and 4 can be electrically operated. First pressure relief line valve 80 may be opened during normal operation providing fluid communication between main line 12 and PRV 82 along pressure relief line 78. Furthermore, in some embodiments, PRV 82 may comprise an electric control valve similar to, or the same as, BOV 22 described above. As such, PRV 82 may comprise a relief poppet similar to, or the same as, valve member 44 describe above.

As described above, electrical energy may be removed from pressure relief pilot valve 90 allowing pressure relief valve (PRV) member 86 to be forced open by the pressure in pressure relief line 78. As such, pressure relief pilot valve 90 may operate the same as, or similar to, pilot valve 24. Here, a pressure transducer monitors the pressure in the pressure relief line 78 or main line 12 and, when the detected pressure reaches a predetermined relief pressure, a controller is operable to de-energize the solenoid of pressure relief pilot valve 90 to open PRV member 86 of PRV 82. As such, PRV 82 is operable as described above in relation to BOV 22.

As PRV member 86 is forced to the open position by the pressure in main line 12 and pressure relief line 78, fluid is allowed to flow through PRV 82 from PRV inlet bore 84 to PRV outlet bore 88. As described above, the pressure imparted on PRV member 86, hydraulic fluid is forced out of the cavity in pressure relief pilot valve 90 providing fluid communication between main line 12 and downstream PRV line 78. The fluid may flow from main line 12 through pressure relief line 78 into PRV inlet bore 84 past PRV member 86 into PRV outlet bore 88. As such, fluid from main line 12 may be provided into the tank along downstream line 76 similarly to the outlet of bleed off fluid described above.

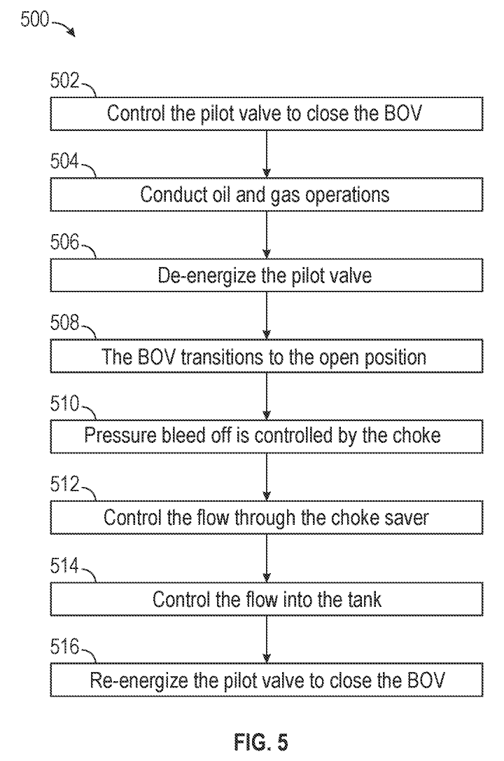

FIG. 5 depicts a flow chart illustrating an exemplary method of bleeding off pressure in main line 12 by bleed off line 10 comprising BOV assembly 20. At step 502, energy is provided to pilot valve 24 to close or maintain the closed position of BOV 22 preventing the fluid from flowing from main line 12 through BOV 22 to downstream line 76. As described above, hydraulic fluid may be forced into chamber 64 locking BOV 22 closed by forcing valve member 44 to the closed position as shown in FIG. 2B. When valve member 44 is closed, normal operations in main line 12 can be conducted without losing pressure to bleed off line 10.

At step 504, normal operations are conducted in main line 12 of the fracturing system while first valve 14 is open and BOV 22 is closed. In some embodiments, first valve 14 may be closed while normal operations are conducted. However, to perform the pressure bleed off procedure described herein, first valve 14 must be open. In some scenarios, maintenance operations must be performed on a section of the fracturing system. As such, pressure should be reduced in a section of main line 12 comprising a coupling to bleed off line 10. Any valves along main line 12 may be actuated to control the flow of fluid through main line 12 prepare for pressure bleed off using BOV assembly 20.

At step 506, electrical energy is removed from solenoid 58 by actuation of a switch or relay device. As described above, when the electrical energy is removed from solenoid 58 hydraulic fluid in chamber 64 is free to exit chamber 64 allowing valve member 44 to move from the closed position of FIG. 2B to the open position of FIG. 2A.

At step 508, valve member 44 is forced open by the pressure in bleed off line 10 causing BOV 22 to open. Once the electrical energy is removed, the force opening BOV 22 is removed. As described above, when the force is removed, BOV 22 is free to open when force is applied from inlet bore 28. As the fluid in main line 12, upstream bleed off line 10, and inlet bore 28 is under pressure, the force is applied to valve member 44. The force on valve member 44 actuates valve member 44 to transition from the closed position illustrated in FIG. 2B to the open position illustrated in FIG. 2A. As described below, the fluid is allowed to flow between inlet bore 28 and outlet bore 32 when BOV 22 is open.

At step 510, fluid flows through BOV 22 to choke 70. After valve member 44 is placed in the open configuration, main line 12 is in fluid communication with choke 70. Choke 70 may be placed downstream of, and adjacent to, outlet bore 32. As such, outlet bore 32 may serve as a flow transition device providing a variable cross-sectional area to transition the flow from BOV 22 to choke 70. As described above, choke 70, in some embodiments, may be bean choke, or an inline choke, with a diameter similar to, or equal to a portion of outlet bore 32. Furthermore, choke 70 may include a center shaft configured to reduce the cross-sectional area exposed to the fluid. As such, the effective cross-sectional area of choke 70 is reduced controlling the flow of the fluid therethrough and controlling the pressure bleed off. However, the internal diameter of the choke 70 may be selected based on the desired pressure bleed off rate.

In some embodiments, choke 70 may not be positioned adjacent to outlet bore 32. Intermediate components may be provided between outlet bore 32 and choke 70. For example, a conduit comprising a variable cross section may be provided. The conduit may provide flow control to increase or decrease the flow rate prior to providing the fluid into choke 70. In some embodiments, a length of conduit may be provided to separate choke 70 from BOV 22 particularly if BOV 22 is a T- or Y-type valve or if turbulence in the flow should be reduced before entering choke 70.

At step 512, the fluid flows downstream of choke 70 where, in some embodiments, choke saver 74 is provided. Choke saver 74 provides an increasing internal diameter to control turbulence and erosion downstream of choke 70. As illustrated in FIG. 4 and described above, choke saver 74 provides an increasing cross-sectional area decreasing the turbulence and, in effect, decreasing erosion of parts downstream. Furthermore, choke saver 74 may be provided at various location downstream such that conduits may be provided between choke 70 and choke saver 74 to further control the flow and/or provide pipe length between choke 70 and choke saver 74.

At step 514, the fluid flows downstream from choke saver 74 into downstream line 76 and into the tank. After the fluid exits choke saver 74, the fluid may be provided into downstream line 76 comprising various conduits and, in some embodiments, additional valves, to control the flow of the fluid to the tank. In some embodiments, the flow into the tank is controlled by additional valves downstream of the tank. In some embodiments, the tank is an open-air tank or may be self-contained.

At step 516, the solenoid 58 of the pilot valve 24 is re-energized to transition BOV 22 from the open position to the closed position. The closing action here may not be nearly as fast as the opening action described above. However, because the pressure in inlet bore 28 is much less after bleed off, BOV 22 and particularly, valve member 44 are not damaged by the flow of the fluid therethrough. As such, actuating valve member 44 to close can be performed by energizing solenoid 58 as described in embodiments above.

In some embodiments, the energizing of solenoid 58 is manually or automatically performed. For example, an operator may simply actuate a switch to energize/de-energize solenoid 58 when a detected pressure in main line 12 and/or bleed off line 10 is detected by a sensor (e.g., pressure transducer). In some embodiments, as described above, pressure transducer may detect the pressure and transmit a signal indicative of the detected pressure to a controller. The controller may transmit a signal by electrical connector 66 to control the pilot valve 24 to provide power to, or remove power from, solenoid 58. As such, control of BOV 22 may be performed (wired or wirelessly) by an operator or automatically by a controller at a remote location.

Furthermore, in some embodiments, the method described above may be provided in parallel with a pressure relief line as shown in FIG. 5. As described above, BOV 22 and PRV 82 may be provided in parallel. BOV assembly 20 and PRV 82 may be coupled to main line 12 and provide outlet into downstream line 76. As the bleed off line and the pressure relief line dump into, in some embodiments, the same dump tank, an additional step of opening/closing a control valve to direct the flow between bleed off line 10 and pressure relief line 78 may be added to the beginning, the end, or at any point during the method 500.

In some aspects, the techniques described herein relate to an electric bleed off valve assembly for bleeding off pressure.

In some aspects, the electric bleed off valve assembly includes a first valve operable to open and close and configured to allow fluid to flow through a bleed off line when open and prevent the fluid from flowing when closed.

In some aspects, the electric bleed off valve assembly includes a bleed off valve provided downstream from the first valve and operable to open under pressure from the fluid and configured to allow the fluid to flow when open and prevent the fluid from flowing when closed.

In some aspects, the techniques described herein relate to an electric bleed off valve assembly wherein the bleed off valve is electrically operable to close and operable to open under pressure from the fluid; and a choke provided downstream of the bleed off valve and operable to restrict flow of the fluid therethrough.

In some aspects, the techniques described herein relate to an electric bleed off valve assembly, wherein the bleed off valve is closed when electrical energy is provided, and a valve member is forced open by the pressure from the fluid when the electrical energy is removed.

In some aspects, the techniques described herein relate to an electric bleed off valve assembly, wherein the bleed off valve includes a solenoid configured to lock the bleed off valve in a closed position.

In some aspects, the techniques described herein relate to an electric bleed off valve assembly, wherein the choke is a bean choke and is configured to reduce a cross-sectional area of the bleed off line to control pressurized bleed off from a main line, wherein the main line is in fluid communication with the bleed off valve.

In some aspects, the techniques described herein relate to an electric bleed off valve assembly, wherein the first valve is an isolation-type valve.

In some aspects, the techniques described herein relate to an electric bleed off valve assembly, further including a bleed off valve outlet bore positioned at a downstream end of the bleed off valve, wherein the bleed off valve outlet bore includes a variable cross section controlling at least a flow rate of the fluid therethrough.

In some aspects, the techniques described herein relate to an electric bleed off valve assembly, wherein the choke is a bean choke and is positioned adjacent to the bleed off valve outlet bore.

In some aspects, the techniques described herein relate to an electric bleed off valve assembly, further including a choke saver positioned downstream of the choke and configured to reduce turbulence in the flow and erosion of downstream components.

In some aspects, the techniques described herein relate to an electric bleed off valve assembly, wherein the choke saver is positioned adjacent to the choke and includes a larger cross-sectional area conduit than the choke.

In some aspects, the techniques described herein relate to an electric bleed off valve assembly for bleeding off pressure, the electric bleed off valve assembly including: a first valve operable to open and close and configured to allow fluid to flow through a bleed off line when open and prevent the fluid from flowing when closed; a bleed off valve provided downstream from the first valve and configured to allow the fluid to flow when open and prevent the fluid from flowing when closed, wherein the bleed off valve is electrically operable to close and operable to open under pressure from the fluid; a choke provided downstream of the bleed off valve and operable to restrict flow of the fluid therethrough; and a pressure relief valve positioned in parallel with the bleed off valve and electrically operable to close and operable to open under pressure from the fluid when the pressure of the fluid is above a pressure threshold.

In some aspects, the techniques described herein relate to an electric bleed off valve assembly, wherein the choke is a bean choke and is configured to reduce a cross-sectional area of the bleed off line to control pressure bleed off in a main line, wherein the main line is in fluid communication with the bleed off valve.

In some aspects, the techniques described herein relate to an electric bleed off valve assembly, wherein the pressure relief valve is positioned along the main line parallel to the bleed off valve, and further including a downstream outlet in fluid communication with the pressure relief valve and the bleed off valve.

In some aspects, the techniques described herein relate to an electric bleed off valve assembly, further including a solenoid configured to close the bleed off valve when energized and configured to allow the bleed off valve to open when de-energized.

In some aspects, the techniques described herein relate to an electric bleed off valve assembly, further including: a pressure transducer configured to detect the pressure in a main line; and a controller configured to de-energize a pressure relief solenoid associated with the pressure relief valve based on the pressure being above the pressure threshold.

In some aspects, the techniques described herein relate to a method of controlling pressure bleed off in a bleed off line, the method including: energizing a solenoid to maintain a closed position of a bleed off valve preventing flow of a fluid through a pressure bleed off line; de-energizing the solenoid allowing the bleed off valve to transition from the closed position to an open position; opening the bleed off valve by providing pressure to a valve member of the bleed off valve and forcing the valve member to actuate allowing the flow of the fluid from upstream of the bleed off valve to downstream of the bleed off valve in the bleed off line; and controlling the flow of the fluid by a choke provided downstream of the bleed off valve.

In some aspects, the techniques described herein relate to a method, wherein the choke is a bean choke and is configured to reduce a cross-sectional area of the bleed off line to control the pressure bleed off in a main line, wherein the main line is in fluid communication with the bleed off valve.

In some aspects, the techniques described herein relate to a method, further including maintaining an isolation-type valve in an open position between the bleed off valve and a main line.

In some aspects, the techniques described herein relate to a method, further including slowing a flow rate of the fluid between the bleed off valve and the choke by increase a flow bore downstream cross-sectional area of an outlet bore of the bleed off valve.

In some aspects, the techniques described herein relate to a method, further controlling a turbulence in the flow of the fluid by a choke saver positioned downstream of the choke.

In some aspects, the techniques described herein relate to a method, wherein the choke saver is positioned adjacent to the choke and includes a larger cross-sectional area conduit of the choke.

Although the invention has been described with reference to the embodiments illustrated in the attached drawing figures, it is noted that equivalents may be employed, and substitutions made herein without departing from the scope of the invention.

Having thus described various embodiments of the disclosure, what is claimed as new and desired to be protected by Letters Patent includes the following:

1. An electric bleed off valve assembly for bleeding off pressure, the electric bleed off valve assembly comprising:
a first valve operable to open and close and configured to allow fluid to flow through a bleed off line when open and prevent the fluid from flowing when closed;
a bleed off valve provided downstream from the first valve and operable to open under pressure from the fluid and configured to allow the fluid to flow when open and prevent the fluid from flowing when closed;
wherein the bleed off valve is electrically operable to close and operable to open under pressure from the fluid; and
a choke provided downstream of the bleed off valve and operable to restrict flow of the fluid therethrough.

2. The electric bleed off valve assembly of claim 1, wherein the bleed off valve is closed when electrical energy is provided, and a valve member is forced open by the pressure from the fluid when the electrical energy is removed.

3. The electric bleed off valve assembly of claim 2, wherein the bleed off valve comprises a solenoid configured to lock the bleed off valve in a closed position.

4. The electric bleed off valve assembly of claim 1,
wherein the choke is a bean choke and is configured to reduce a cross-sectional area of the bleed off line to control pressurized bleed off from a main line,
wherein the main line is in fluid communication with the bleed off valve.

5. The electric bleed off valve assembly of claim 1, wherein the first valve is an isolation-type valve.

6. The electric bleed off valve assembly of claim 1,
further comprising a bleed off valve outlet bore positioned at a downstream end of the bleed off valve,
wherein the bleed off valve outlet bore comprises a variable cross section controlling at least a flow rate of the fluid therethrough.

7. The electric bleed off valve assembly of claim 6, wherein the choke is a bean choke and is positioned adjacent to the bleed off valve outlet bore.

8. The electric bleed off valve assembly of claim 1, further comprising a choke saver positioned downstream of the choke and configured to reduce turbulence in the flow and erosion of downstream components.

9. The electric bleed off valve assembly of claim 8, wherein the choke saver is positioned adjacent to the choke and comprises a larger cross-sectional area conduit than the choke.

10. An electric bleed off valve assembly for bleeding off pressure, the electric bleed off valve assembly comprising:
a first valve operable to open and close and configured to allow fluid to flow through a bleed off line when open and prevent the fluid from flowing when closed;
a bleed off valve provided downstream from the first valve and configured to allow the fluid to flow when open and prevent the fluid from flowing when closed,
wherein the bleed off valve is electrically operable to close and operable to open under pressure from the fluid;
a choke provided downstream of the bleed off valve and operable to restrict flow of the fluid therethrough; and
a pressure relief valve positioned in parallel with the bleed off valve and electrically operable to close and operable to open under pressure from the fluid when the pressure of the fluid is above a pressure threshold.

11. The electric bleed off valve assembly of claim 10,
wherein the choke is a bean choke and is configured to reduce a cross-sectional area of the bleed off line to control pressure bleed off in a main line,
wherein the main line is in fluid communication with the bleed off valve.

12. The electric bleed off valve assembly of claim 11,
wherein the pressure relief valve is positioned along the main line parallel to the bleed off valve, and
further comprising a downstream outlet in fluid communication with the pressure relief valve and the bleed off valve.

13. The electric bleed off valve assembly of claim 10, further comprising a solenoid configured to close the bleed off valve when energized and configured to allow the bleed off valve to open when de-energized.

14. The electric bleed off valve assembly of claim 10, further comprising:
a pressure transducer configured to detect the pressure in a main line; and
a controller configured to de-energize a pressure relief solenoid associated with the pressure relief valve based on the pressure being above the pressure threshold.

15. A method of controlling pressure bleed off in a bleed off line, the method comprising:
energizing a solenoid to maintain a closed position of a bleed off valve preventing flow of a fluid through a pressure bleed off line;
de-energizing the solenoid allowing the bleed off valve to transition from the closed position to an open position;
opening the bleed off valve by providing pressure to a valve member of the bleed off valve and forcing the valve member to actuate allowing the flow of the fluid from upstream of the bleed off valve to downstream of the bleed off valve in the bleed off line; and
controlling the flow of the fluid by a choke provided downstream of the bleed off valve.

16. The method of claim 15,
wherein the choke is a bean choke and is configured to reduce a cross-sectional area of the bleed off line to control the pressure bleed off in a main line,
wherein the main line is in fluid communication with the bleed off valve.

17. The method of claim 15, further comprising maintaining an isolation-type valve in an open position between the bleed off valve and a main line.

18. The method of claim 15, further comprising slowing a flow rate of the fluid between the bleed off valve and the choke by increase a flow bore downstream cross-sectional area of an outlet bore of the bleed off valve.

19. The method of claim 15, further controlling a turbulence in the flow of the fluid by a choke saver positioned downstream of the choke.

20. The method of claim 19, wherein the choke saver is positioned adjacent to the choke and comprises a larger cross-sectional area conduit of the choke.
